(19) United States
(12) Patent Application Publication
(10) Pub. No.: US 2024/0426048 A1
(43) Pub. Date: Dec. 26, 2024

(54) SILICONE RUBBER COMPOSITION FOR TEXTILE COATING AND SILICONE RUBBER-COATED TEXTILE

(71) Applicants: DOW TORAY CO., LTD., Shinagawa-ku, Tokyo (JP); DOW SILICONES CORPORATION, Midland, MI (US)

(72) Inventors: Hiroshi AKITOMO, Ichihara-shi, Chiba (JP); Dongchan AHN, Midland, MI (US)

(21) Appl. No.: 18/704,951

(22) PCT Filed: Oct. 26, 2022
(86) PCT No.: PCT/US2022/047844

§ 371 Date: Apr. 26, 2024

Related U.S. Application Data
(60) Provisional application No. 63/273,298, filed on Oct. 29, 2021.

(51) Int. Cl. D06N 3/12; D06N 3/00

(52) U.S. Cl. CPC D06N 3/128; D06N 3/0063; D10B 2401/061; D10B 2401/063; D10B 2505/124

(57) ABSTRACT

A silicone rubber composition for textile coating is provided. The composition comprises: (A) an organopolysiloxane having on average at least one alkenyl group per molecule and having a viscosity at 25° C. of from 100 to 1,000,000 mPa s; (B) an organopolysiloxane having at least two silicon atom-bonded hydrogen atoms per molecule, wherein a content of the silicon atom-bonded hydrogen atoms is 0.5 mass % or less; (C) a hydrosilylation catalyst; (D) a reinforcing silica fine powder; (E) an adhesion promoter; and (F) an amino group-containing triazine compound, or a compound having a phenol backbone and an amide bond, wherein each compound has a molecular weight of from 120 to 700. The composition has good curability, and forms a silicone rubber with high elongation and small change in elongation even when the silicone rubber is subjected to heat-aging.

### CROSS-REFERENCE TO RELATED APPLICATIONS

This application claims priority to and all advantages of U.S. Provisional Patent Application No. 63/273,298 filed on 29 Oct. 2021, the content of which is incorporated herein by reference.

### TECHNICAL FIELD

The present invention relates to a silicone rubber composition for textile coating, and a silicone rubber-coated textile obtained by coating a textile with the composition.

### BACKGROUND ART

A silicone rubber-coated textile, which is produced by coating a textile with a silicone rubber composition, has been used in airbags for vehicles and the like. Such a silicone rubber is required to have a good adhesion property to the textile, which serves as a base fabric of an airbag, and pliability exhibited when an airbag is deployed.

As such a silicone rubber composition, a hydrosilylation curing type composition is preferable. For example, a silicone rubber composition comprising: a diorganopolysiloxane having at least two alkenyl groups per molecule, an organopolysiloxane resin, a silica fine powder having a specific surface area of 50 m²/g or greater, an organohydrogenpolysiloxane having at least two silicon atom-bonded hydrogen atoms per molecule, a hydrosilylation catalyst, an organosilicon compound having an adhesion-imparting functional group, and an organotitanium compound and/or an organozirconium compound (see Patent Document 1); a silicone rubber composition comprising: an organopolysiloxane having at least two alkenyl groups per molecule, wherein a content of the alkenyl groups is less than 2 mass %, an organopolysiloxane having at least two alkenyl groups per molecule, wherein a content of the alkenyl groups is 5 mass % or more, an organohydrogenpolysiloxane having on average at least three silicon atom-bonded hydrogen atoms per molecule, an organohydrogenpolysiloxane having on average two silicon atom-bonded hydrogen atoms per molecule, a hydrosilylation catalyst, and a reinforcing silica fine powder (see Patent Document 2); a silicone rubber composition comprising: an organopolysiloxane having on average at least one alkenyl group per molecule, an organohydrogenpolysiloxane having at least three silicon atom-bonded hydrogen atoms per molecule, wherein at least one hydrogen atom bonds to silicon atom in the molecular chain, an organohydrogenpolysiloxane having silicon atom-bonded hydrogen atoms at only both molecular chain terminals, a hydrosilylation catalyst, a reinforcing silica fine powder, and an adhesion promoter (see Patent Document 3); and a silicone rubber composition comprising: an organopolysiloxane having at least two alkenyl groups per molecule and having a viscosity at 25° C. of from 100 to 1,000,000 mPa·s, a branched chain organopolysiloxane having at least two silicon atom-bonded hydrogen atoms per molecule, a hydrosilylation catalyst, a reinforcing silica fine powder, an organotitanium compound and/or organozirconium compound, and a silanol group-containing organosiloxane oligomer (see Patent Document 4) have been proposed.

Such a silicone rubber composition forms silicone rubber with high elongation, however, when the silicone rubber was subjected to heat-aging, the silicone rubber has a problem that change in elongation was significantly increased.

While, each of Patent Documents 5 and 6 has proposed a hydrosilylation curing type silicone rubber composition containing a triazole compound to reduce a compression set and to improve flame retardancy of silicone rubber obtained by curing the composition.

However, the silicone rubber composition described in each of Patent Documents 5 and 6 has poor curability, so it has a problem that it is not suitable for use as a silicone rubber composition for textile coating.

Further, Patent Document 7 has proposed a hydrosilylation curing type silicone rubber composition containing 0.001 to 5 mass % of a metal deactivator such as a diacylhydrazide compound, an aminotriazole compound, an aminotrizine compound, and the like, and 0.001 to 5 mass % of a curing-retarder selected from an alcohol derivative having carbon-carbon triple bonds, an enyne compound, an alkenyl-containing low-molecular-weight organosiloxane compound, or an alkyne-containing silane to form silicone rubber with low compression set without resorting to secondary thermal treatment.

However, Patent Document 7 is not interested in the problem to provide a silicone rubber composition for textile coating, wherein the composition has good curability and forms to silicone rubber on the silicone rubber-coated textile has small change in elongation even when the silicone rubber is subjected to heat-aging.

### CITATION LIST

### Patent Literature

Patent Document 1: United States Patent Application Publication No. 2006/0286390 A1
Patent Document 2: United States Patent Application Publication No. 2010/0190395 A1
Patent Document 3: United States Patent Application Publication No. 2013/0071591 A1
Patent Document 4: United States Patent Application Publication No. 2019/0092969 A1
Patent Document 5: U.S. Pat. No. 5,104,919 A
Patent Document 6: Japanese Patent Application Publication No. H04-033961 A
Patent Document 7: United States Patent Application Publication No. 2010/0144933 A1

### SUMMARY OF INVENTION

### Technical Problem

An objective of the present invention is to provide a silicone rubber composition for textile coating, which has good curability, and forms a silicone rubber with high elongation and small change in elongation even when the silicone rubber is subjected to heat-aging. Another objective of the present invention is to provide a silicone rubber-coated textile in which a silicone rubber coated the textile has high elongation and small change in elongation even when the silicon rubber is subjected to heat-aging.

### Solution to Problem

The silicone rubber composition for textile coating of the present invention, comprises:
(A) 100 parts by mass of an organopolysiloxane having on average at least one alkenyl group per molecule and having a viscosity at 25° C. of from 100 to 1,000,000 mPa·s;
(B) an organopolysiloxane having at least two silicon atom-bonded hydrogen atoms per molecule, wherein a content of the silicon atom-bonded hydrogen atoms is 0.5 mass % or less, in an amount such that the silicon atom-bonded hydrogen atoms are 0.5 to 20 moles per one mole of alkenyl groups in component (A);
(C) a catalytic amount of a hydrosilylation catalyst;
(D) 0.1 to 50 parts by mass of a reinforcing silica fine powder;
(E) 0.05 to 5 parts by mass of an adhesion promoter; and
(F) 0.001 to 5 parts by mass of an amino group-containing triazine compound, or a compound having a phenol backbone and an amide bond, wherein each compound has a molecular weight of from 120 to 700.

In various embodiments, component (E) is at least one selected from a group consisting of (E-1) an organotitanium compound and/or an organozirconium compound; (E-2) an epoxy group-containing alkoxysilane and/or an acryl group- or methacryl group-containing alkoxysilane; (E-3) a diorganosiloxane oligomer blocked with silanol groups at both molecular chain terminals; and a reaction product of components (E-2) and (E3).

In various embodiments, component (F) has a melting point of 80° C. or more, and 300° C. or less, wherein the melting point is measured by means of a differential scanning calorimetry (DSC). While, in various embodiments, the amino group-containing triazine compound for component (F) is typically 2,4,6-triamino-1,3,5-triazine, the compound having a phenol backbone and an amide bond for component (F) is typically a triazole compound, a diamine compound or a hydrazine compound.

In various embodiments, the silicone rubber composition for textile coating further comprises: (G) a hydrosilylation retardant, in an amount of from 0.001 to 5 parts by mass per 100 parts by mass of component (A).

The silicone rubber-coated textile of the present invention is formed by coating a textile with the silicone rubber composition for textile coating described above, and then curing the composition. In various embodiments, the textile is typically a base fabric for an airbag.

### Effects of Invention

The silicone rubber composition for textile coating of the present invention, has good curability, and forms a silicone rubber with high elongation and small change in elongation even when the silicone rubber is subjected to heat-aging. While, the silicone rubber-coated textile of the present invention is characterized that silicone rubber coated on the textile has high elongation and small change in elongation even when the silicone rubber is subjected to heat-aging.

### DETAILED DESCRIPTION OF THE INVENTION

### Definitions

The term “viscosity” as used herein means, as for organopolysiloxanes, a value at 25° C. measured using a B-type rotational viscometer in accordance with JIS K7117-1:1999 “Plastics-Resins in the liquid state or as emulsions or dispersions—Determination of apparent viscosity by the Brookfield Test method,” and as for silicone rubber compositions, a value at 25° C. measured using a rotational rheometer (a viscoelasticity measuring device AR 2000 manufactured by TA Instrument) in accordance with JIS K7117-2:1999 “Plastics-Polymers/resins in the liquid state or as emulsions or dispersions-Determination of viscosity using a rotational viscometer with defined shear rate.”

The term “elongation” as used herein refers to “elongation at break” in accordance with JIS K 6251:2004 “Rubber, vulcanized or thermoplastic-Determination of tensile stress-strain properties.”

The term “phenol backbone” as used herein means a molecular structure in which a hydroxy group bonds to a benzene ring constituting a compound, for example, it means an unsubstituted or alkyl group-substituted phenol group, or an unsubstituted hydroxyphenylene group. Such an unsubstituted or alkyl group-substituted phenol groups is typically represented by the following general formula:

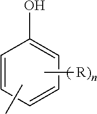

In the formula above, R is a straight-chain or branched-chain alkyl group having 1 to 12 carbon atoms, and “n” is an integer of from 0 to 4.

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “>” is “at least” or “greater-than or equal to”; a “<” is “below” or “less-than”; and a “s” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

### <Silicone Rubber Composition for Textile Coating>

First, the silicone rubber composition for textile coating of the present invention will be described in detail.

Component (A) is an organopolysiloxane having on average at least one alkenyl group per molecule. Examples of the alkenyl groups in component (A) include alkenyl groups having 2 to 12 carbon atoms such as vinyl groups, allyl groups, butenyl groups, pentenyl groups, hexenyl groups, heptenyl groups, and the like, and vinyl groups are preferred. Furthermore, examples of groups bonded to silicon atoms other than the alkenyl groups in component (A) include: methyl groups, ethyl groups, propyl groups, butyl groups, pentyl groups, hexyl groups, heptyl groups, and other alkyl groups having 1 to 12 carbon atoms; phenyl groups, tolyl groups, xylyl groups, and other aryl groups having 6 to 12 carbon atoms; benzyl groups, phenethyl groups, and other aralkyl groups having 7 to 12 carbon atoms; and 3,3,3-trifluoropropyl groups, and other fluoroalkyl groups having 3 to 12 carbon atoms. Methyl groups are preferred. Furthermore, a small amount of hydroxyl groups; or methoxy groups, ethoxy groups, and other alkoxy groups having 1 to 3 carbon atoms may be bonded to the silicon atom in component (A) within a scope that does not impair an object of the present invention.

A molecular structure of component (A) is not particularly limited, and examples include straight chain structures, partially branched straight chain structures, cyclic structures, branched chain structures, mesh structures, and dendritic structures. Straight chain structures and partially branched straight chain structures are preferred. Component (A) may be a mixture having two or more types of these molecular structures.

A viscosity at 25° C. of component (A) is within a range of 100 to 1,000,000 mPa·s, and optionally within a range of 300 to 100,000 mPa·s. This is because if the viscosity of component (A) is equal to or above the lower limit of the aforementioned range, the mechanical properties of the obtained silicone rubber will be enhanced. In contrast, if the viscosity is equal to or below the upper limit of the aforementioned range, the coatability of the present composition will be enhanced.

Examples of such organopolysiloxanes for component (A) include: dimethylpolysiloxanes blocked with dimethylvinylsiloxy groups at both molecular chain terminals; copolymers of dimethylsiloxane and methylvinylsiloxane blocked with dimethylvinylsiloxy groups at both molecular chain terminals; copolymers of dimethylsiloxane and methylvinylsiloxane blocked with trimethylsiloxy groups at both molecular chain terminals; organopolysiloxanes consisting of siloxane units represented by the formula: (CH₃)₃SiO_{1/2}, siloxane units represented by the formula: (CH₂═CH) (CH₃)₂SiO_{1/2} and siloxane units represented by the formula: SiO_{4/2} units; organopolysiloxanes consisting of siloxane units represented by the formula: (CH₂═CH) (CH₃)₂SiO_{1/2}, siloxane units represented by the formula: (CH₃)₃SiO_{1/2} and siloxane units represented by the formula: CH₃SiO_{3/2} units; organopolysiloxanes in which a portion or all of methyl groups of these organopolysiloxanes are substituted with alkyl groups other than methyl groups such as ethyl groups, propyl groups, and the like; aryl groups such as phenyl groups, tolyl groups, and the like; aralkyl groups such as benzyl groups, phenethyl groups, and the like; or fluoroalkyl groups such as 3,3,3-trifluoropropyl groups, and the like; organopolysiloxanes in which a portion or all of vinyl groups of these organopolysiloxanes are substituted with alkenyl groups other than vinyl groups such as allyl groups, butenyl groups, and the like; and mixtures of two or more of these organopolysiloxanes.

Component (B) is an organopolysiloxane having at least two silicon atom-bonded hydrogen atoms per molecule. Examples of groups bonded to silicon atoms in component (B) include: methyl groups, ethyl groups, propyl groups, butyl groups, pentyl groups, hexyl groups, heptyl groups, and other alkyl groups having 1 to 6 carbon atoms; phenyl groups, tolyl groups, and other aryl groups having 6 to 12 carbon atoms; benzyl groups, phenethyl groups, and other aralkyl groups having 7 to 12 carbon atoms; or 3,3,3-trifluoropropyl groups and other fluoroalkyl groups having 1 to 6 carbon atoms. Methyl groups are preferred. Furthermore, a small amount of hydroxyl groups; or methoxy groups, ethoxy groups, and other alkoxy groups having 1 to 3 carbon atoms may be bonded to the silicon atom in component (B) within a scope that does not impair an object of the present invention.

A content of silicon atom-bonded hydrogen atoms in component (B) is 0.5 mass % or less. This is because if the content of silicone atom-bonded hydrogen atoms in component (B) is equal to or below the aforementioned upper limit, elongation of the silicone rubber obtained by curing the present composition will be enhanced. As for the content of silicon atom-bonded hydrogen atoms in component (B), an organopolysiloxane with its content of more than 0.5 mass % and another organopolysiloxane with its content of less than 0.5 mass % may be mixed to adjust 0.5 mass % or less.

A molecular structure of component (B) is not particularly limited, and examples include straight chain structures, partially branched straight chain structures, cyclic structures, branched chain structures, mesh structures, and dendritic structures. Straight chain structures and partially branched straight chain structures are preferred. Component (B) may be a mixture having two or more types of these molecular structures.

While not particularly limited, a viscosity at 25° C. of component (B) is generally within a range of 1 to 1,000 mPa·s, or within a range of 1 to 500 mPa·s. This is because if the viscosity of component (B) is equal to or above the lower limit of the aforementioned range, the mechanical properties of the silicone rubber obtained by curing the present composition will be enhanced. In contrast, if the viscosity is equal to or below the upper limit of the aforementioned range, the coatability of the present composition will be enhanced.

Examples of organopolysiloxanes for component (B) include methylhydrogenpolysiloxanes blocked with trimethylsiloxy groups at both molecular chain terminals; copolymers of dimethylsiloxane and methylhydrogensiloxane blocked with trimethylsiloxy groups at both molecular chain terminals; dimethylpolysiloxanes blocked with dimethylhydrogensiloxy groups at both molecular chain terminals; copolymers of dimethylsiloxane and methylhydrogensiloxane blocked with dimethylhydrogensiloxy groups at both molecular chain terminals; copolymers of methylphenylsiloxane and methylhydrogensiloxane blocked with dimethylphenylsiloxy groups at both molecular chain terminals; cyclic methylhydrogenpolysiloxanes; organopolysiloxanes consisting of siloxane units represented by the formula: H(CH₃)₂SiO_{1/2} and siloxane units represented by the formula: SiO_{4/2} units; organopolysiloxanes consisting of siloxane units represented by the formula: H(CH₃)₂SiO_{1/2}, siloxane units represented by the formula: (CH₃)₃SiO_{1/2} and siloxane units represented by the formula: SiO_{4/2} units; organopolysiloxanes consisting of siloxane units represented by the formula: (CH₃)₂SiO_{2/2}, siloxane units represented by the formula: H(CH₃) SiO_{2/2} and siloxane units represented by the formula: CH₃SiO_{3/2} units; organopolysiloxanes consisting of siloxane units represented by the formula: (CH₃)₃SiO_{1/2}, siloxane units represented by the formula: (CH₃)₂SiO_{2/2}, siloxane units represented by the formula: H(CH₃) SiO_{2/2} and siloxane units represented by the formula: CH₃SiO_{3/2} units; organopolysiloxanes in which a portion or all of methyl groups of these organopolysiloxanes are substituted with alkyl groups other than methyl groups such as ethyl groups, propyl groups, and the like; aryl groups such as phenyl groups, tolyl groups, and the like; aralkyl groups such as benzyl groups, phenethyl groups, and the like; or fluoroalkyl groups such as 3,3,3-trifluoropropyl groups, and the like; and mixtures of two or more of these organopolysiloxanes.

The amount of component (B) is an amount such that silicon atom-bonded hydrogen atoms in component (B) are within a range of 0.5 to 20 mols, and optionally within a range of 1 to 15 mols, relative to 1 mol of the alkenyl groups in component (A). This is because if the amount of component (B) is equal to or above the lower limit of the aforementioned range, the present composition will be sufficiently cured and adhered to the textile. However, on the other hand, if the amount is equal to or below the upper limit of the aforementioned range, the mechanical properties such as elongation of silicone rubber obtained by curing the present composition will be enhanced.

Component (C) is a hydrosilylation catalyst for accelerating curing of the present composition. Examples of component (C) include platinum metal-type catalysts, such as platinum catalysts, rhodium catalysts, ruthenium catalysts, iridium catalysts, and palladium catalysts. Of these, a platinum catalyst is preferred. Examples of the platinum catalysts include finely powdered platinum, chloroplatinic acid, alcohol solutions of chloroplatinic acid, olefin complexes of chloroplatinic acid, alkenylsiloxane complexes of chloroplatinic acid, diketone complexes of platinum, alkenylsiloxane complexes of platinum, olefin complexes of platinum; metal platinum supported on silica, aluminum, carbon, or the like; and thermoplastic resin powder containing these platinum catalysts. Furthermore, examples of the platinum metal-type catalysts other than the platinum catalysts include RhCl(PPh₃)₃, RhCl(CO) (PPh₃)₂, Ru₃(CO)₁₂, IrCl(CO)(PPh₃)₂, and Pd(PPh₃)₄. Note that, in the formulas, Ph is a phenyl group.

The amount of component (C) is not limited as long as the content is an amount that accelerates the curing of the present composition. Typically, the amount of component (C) is within a range of 0.1 to 1,000 ppm, within a range of 0.1 to 500 ppm, or within a range of 5 to 500 ppm, or within a range of 0.1 to 300 ppm, or within a range of 5 to 300 ppm, of catalytic metal in component (C) in terms of mass units relative to a total mass of components (A) to (C). This is because when the amount of component (C) is greater than or equal to the lower limit of the aforementioned range, curability of the present composition is good, whereas when the amount of component (C) is less than or equal to the upper limit of the aforementioned range, coloration of the silicone rubber obtained by curing the present composition is suppressed.

Component (D) is a reinforcing silica fine powder to impart mechanical strength to the silicone rubber obtained by curing the present composition. Examples of such component (D) include dry-process silica, precipitated silica, and hydrophobic silica formed by subjecting the surface of such reinforcing silica fine powders to treatment with an organosilicon compound, such as organochlorosilane, organosilazane, organoalkoxysilane, or organohydrogenpolysiloxane. In particular, component (D) generally has a specific surface area of 50 m²/g or greater.

The amount of component (D) is in a range of 0.1 to 50 parts by mass, and optionally in a range of 5 to 40 parts by mass, relative to 100 parts by mass of component (A). This is because, when the amount of component (D) is equal to or above the lower limit of the range described above, excellent mechanical strength of the silicone rubber obtained by curing the present composition is achieved, and when the amount is equal to or below the upper limit of the range described above, excellent coatability of the present composition is achieved.

Component (E) is an adhesion promoter to impart adhesion to the present composition. Typically, component (E) is at least one selected from a group consisting of (E-1) an organotitanium compound and/or an organozirconium compound, (E-2) an epoxy group-containing alkoxysilane and/or an acryl group- or methacryl group-containing alkoxysilane; (E-3) a diorganosiloxane oligomer blocked with silanol groups at both molecular chain terminals; and a reaction product of components (E-2) and (E3).

Examples of the organotitanium compound for component (E-1) include organotitanic acid esters such as tetraisopropyl titanate, tetrabutyl titanate, tetraoctyl titanate, and the like; titanium organic acid salts such as titanium acetic acid salts, and the like; and titanium chelate compounds such as titanium diisopropoxybis(acetylacetonate), titanium diisopropoxybis(ethyl acetoacetate), and the like.

Furthermore, examples of the organozirconium compound for component (E-1) include zirconium tetraacetylacetonate, zirconium hexafluoroacetylacetonate, zirconium trifluoroacetylacetonate, tetrakis(ethyltrifluoroacetylacetonate) zirconium, tetrakis(2,2,6,6-tetramethyl-heptanedionate), zirconium dibutoxybis(ethylacetoacetate), and zirconium diisopropoxybis(2,2,6,6-tetramethyl-heptanedionate).

Furthermore, examples of the epoxy group-containing alkoxysilane for component (E-2) include 3-glycidoxypropyltrimethoxysilane, 3-glycidoxypropyltriethoxysilane, 3-glycidoxypropylmethyldimethoxysilane, 4-glycidoxybutyltrimethoxysilane, 5,6-epoxyhexyltriethoxysilane, 2-(3,4-epoxycyclohexyl)ethyltrimethoxysilane, and 2-(3,4-epoxycyclohexyl)ethyltriethoxysilane.

Furthermore, examples of the acryl group- or methacryl group-containing alkoxysilane for component (E-2) include 3-methacryloxypropyltrimethoxysilane, 3-methacryloxypropyltriethoxysilane, 3-methacryloxypropylmethyldimethoxysilane and 3-acryloxypropyltrimethoxysilane.

While not particularly limited, a viscosity at 25° C. of component (E-3) is generally less than 100 mPa·s, or within a range of 1 to 50 mPa·s. Examples of the diorganosiloxane oligomers blocked with silanol groups at both molecular chain terminals for component (E-3) include methylvinylsiloxane oligomers blocked with silanol groups at both molecular chain terminals; copolymeric oligomers of dimethylsiloxane and methylvinylsiloxane blocked with silanol groups at both molecular chain terminals; methylvinylsiloxane oligomers blocked with silanol groups at both molecular chain terminals; organosiloxane oligomers in which a portion or all of methyl groups of these organosiloxane oligomers are substituted with alkyl groups other than methyl groups such as ethyl groups, propyl groups, and the like; aryl groups such as phenyl groups, tolyl groups, and the like; aralkyl groups such as benzyl groups, phenethyl groups, and the like; or fluoroalkyl groups such as 3,3,3-trifluoropropyl groups, and the like; organosiloxane oligomers in which a portion or all of vinyl groups of these organosiloxane oligomers are substituted with alkenyl groups other than vinyl groups such as allyl groups, butenyl groups, and the like; and mixtures of two or more of these organosiloxane oligomers.

In the present composition, the amount of component (E) is in a range of 0.05 to 5 parts by mass, and optionally in a range of 0.1 to 5 part by mass, relative to 100 parts by mass of component (A). This is because, when the amount of component (E) is equal to or above the lower limit of the range described above, excellent adhesion can be imparted to a textile with poor adhesion, such as a hollow-woven textile. On the other hand, when the amount is equal to or below the upper limit of the range described above, storage stability of the present composition is enhanced.

While, when component (E-1) is used with component (E-2) and/or component (E-3), or a reaction product of components (E-2) and (E-3), the amount of component (E-1) is typically in a range of 0.01 to 1 parts by mass relative to 100 parts by mass of component (A), and when component (E-3) is used with component (E-2) further, the amount of component (E-3) is typically in a range of 0.01 to 1 parts by mass.

Component (F) is a component to suppress a change in elongation of the silicone rubber obtained by curing the present composition after heat-aging without impairing curability of the present composition. Component (F) has a molecular weight of from 120 to 700, and is an amino group-containing triazine compound or a compound having a phenol backbone and an amide bond. Typically, component (F) has a melting point of 80° C. or more, and 300° C. or less, wherein the melting point is measured by means of a differential scanning calorimetry (DSC). The melting point can be measured by a differential scanning calorimeter (DSC) according to JIS K 7121-1978 “Testing Methods for Transition Temperatures of Plastics.” In this apparatus, a pan for DSC measurement in which a polyester resin (A) sample was sealed was set, heated to 320° C. at a heating rate of 10° C./min in a nitrogen atmosphere, and held at that temperature for 5 minutes. The temperature is decreased to 30° C. by measuring the temperature decrease at 10° C./min. The temperature at the top of the endothermic peak at the time of temperature rise is defined as the “melting point.”

Examples of amino group-containing triazine compound for component (F) include 2,4,6-triamino-1,3,5-triazine, 2,4-diamino-6-methyl-1,3,5-triazine and 2,4-diamino-6-phenyl-1,3,5-triazine. The amino group-containing triazine compounds are available as ADK STAB ZS-27 produced by ADEKA.

Examples of compounds having a phenol backbone and an amide bond for component (F) include compounds having a group represented by the following general formula:

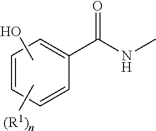

or a group represented by the following general formula:

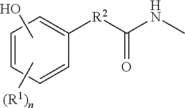

In the formulas above, R¹ is a straight-chain or branched-chain alkyl group having 1 to 12 carbon atoms. Examples of the alkyl groups for R¹ include methyl groups, ethyl groups, n-propyl groups, isopropyl groups, n-butyl groups, isobutyl groups, tert-butyl groups, n-pentyl groups, neopentyl groups, hexyl groups, octyl groups, nonyl groups, decyl groups, and the like.

In the formula above, R² is an alkylene group having 1 to 12 carbon atoms. Examples of the alkylene groups for R² include methylene groups, ethylene groups, propylene groups, butylene groups, pentylene groups, hexylene groups, octylene groups, and the like.

In the formulas above, “n” is an integer of from 0 to 4, typically, an integer of from 0 to 2.

Examples of such component (F) include triazole compounds, diamine compounds and hydrazine compounds. Examples of such triazole compounds include 3-(N-salicyloyl)amino-1,2,4-triazole, 3-(N-salicyloyl)amino-5-methyl-1,2,4-triazole and 3-(N-acetyl)amino-1,2,4-triazole-5-carboxylic acid. The triazole compounds are available as ADK STAB CDA-1 produced by ADEKA and ADK STAB CDA-1M produced by ADEKA.

Furthermore, examples of such diamine compounds and hydrazine compounds include N,N′-bis [3-(3,5-di-tert-butyl-4-hydroxyphenyl) propionyl]hexamethylenediamine, N,N′-disalicyloylhydrazine, N-formyl-N′-salicyloylhydrazine, N-acetyl-N′-salicyloylhydrazine, N, N′-bis [3-(3,5-di-tert-butyl-4-hydroxyphenyl) propionyl]hydrazine, 1-N, 12-N-bis(2-hydroxybenzoyl) dodecane dihydrazide, oxalic acid-di-(N-salicyloylhydrazide), adipic acid-di-(N′-salicyloylhydrazide) and dodecane dioyl-di-(N′-salicyloylhydrazide). The diamine compounds and hydrazine compounds are available as ADK STAB CDA-6 produced by ADEKA, ADK STAB CDA-6S produced by ADEKA, ADK STAB CDA-10 produced by ADEKA, IRGANOX® MD-1024 produced by BASF and ANTAGE HP-300 produced by Kawaguchi Chemical Industry.

In the present composition, the amount of component (F) is in a range of 0.001 to 5 parts by mass, and optionally in a range of 0.05 to 5 part by mass, relative to 100 parts by mass of component (A). This is because, when the amount of component (F) is equal to or above the lower limit of the range described above, the silicone rubber obtained by curing the present composition has small change in elongation even when the silicone rubber is subjected to heat-aging. On the other hand, when the amount is equal to or below the upper limit of the range described above, the present composition has good curability.

In certain embodiments, the present composition contains (G) a hydrosilylation retardant to control a pot life thereof. Examples of such compound (G) include: 1-ethynyl-cyclohexan-1-ol, 2-methyl-3-butyn-2-ol, 3,5-dimethyl-1-hexyn-3-ol, 2-phenyl-3-butyn-2-ol, and other acetylene compounds; 3-methyl-3-penten-1-yne, 3,5-dimethyl-3-hexen-1-yne, and other enyne compounds; methyl-tris(1,1-dimethyl-2-propinoxy) silane, vinyl-tris(1,1-dimethyl-2-propinoxy) silane, and other alkynoxysilane compounds; and other phosphine and mercaptan compounds. The amount of such component (G) is not limited, but is generally within a range of 0.001 to 5 parts by mass, or 0.01 to 10 parts by mass, relative to 100 parts by mass of component (A).

Furthermore, the present composition may contain an inorganic filler other than component (D) as long as the object of the present invention is not impaired. Examples of such an inorganic filler include extender fillers such as quartz powder, diatomaceous earth, calcium carbonate, and magnesium carbonate; heat resistance agents such as cerium oxide, cerium hydroxide, and iron oxide; pigments, such as red iron oxide, titanium oxide, and carbon black; and flame retardant.

A method of preparing the present composition is not limited, and the present composition can be prepared by mixing component (A) to component (F) and, as necessary, other optional components. However, a method is preferred in which, to a silica master batch prepared by heating and mixing a part of component (A) and component (D) in advance, the rest of component (A), component (B), component (C), component (E), and component (F) are blended. Note that, in the case where other optional components need to be blended, such blending may be performed during the preparation of the silica master batch. Furthermore, in the case where the other optional components are altered by heating and mixing, the other optional components are generally blended during the blending of the rest of component (A), component (B), component (C), component (E), and component (F). Furthermore, when the silica master batch is prepared, the organosilicon compound may be blended and component (D) may be subjected to an in-situ surface treatment. The present composition may be prepared using a two-roll, a kneader/mixer, a Ross mixer, or similar known kneading apparatus.

Furthermore, to enhance storage stability, the present composition is typically a two-component silicone rubber composition for textile coating formed from a composition (I) containing component (A), component (C), and component (D), but containing no component (B), and a composition (II) containing component (A), component (B), and component (D), but containing no component (C). Note that component (E) and component (F) may be contained in one or both of the composition (I) and the composition (II).

A state at 25° C. of the present composition is not limited, but is generally a liquid. The viscosity at 25° C. of the composition is not limited, but is generally in a range of 10 to 500 Pa·s, or in a range of 50 to 500 Pa·s. The present composition having such a viscosity can be coated on a textile as a solventless composition containing no solvent for adjusting the viscosity, achieves excellent handleability and coating workability, and is less likely to cause defects in the silicone rubber coating layer.

### <Silicone Rubber-Coated Textile>

Next, the silicone rubber-coated textile of the present invention will be described in detail.

The silicone rubber-coated textile of the present invention is formed by coating the silicone rubber composition for textile coating described above on a surface of a textile and curing the composition. Examples of the textile of the present coated textile include polyamide fiber textiles such as nylon 6, nylon 66, and nylon 46; polyester fiber textiles such as polyethylene terephthalate, polybutylene terephthalate, and polytrimethylene terephthalate; as well as polyacryl fiber textiles, polyacrylonitrile fiber textiles, aramid fiber textiles, polyether imide fiber textiles, polysulfone-based fiber textiles, carbon fiber textiles, rayon fiber textiles, polypropylene fiber textiles, polyethylene fiber textiles, and nonwoven fabrics formed from these fibers. In particular, as a base fabric of an airbag, a polyamide fiber textile or a polyester fiber textile is preferred from the perspective of excellent heat resistance and mechanical characteristics.

A textile structure of the present coated textile is not limited, but is typically a plain weave from the perspectives of productivity and thickness. Furthermore, since the coated film having excellent adhesion can be formed on a hollow-woven textile which has poor adhesion, the textile may be a hollow-woven textile having a bag-like hollow in the central portion of the textile structure.

A method of producing the present coated textile is not limited, and the silicone rubber composition for textile coating can be coated on the textile by a publicly known method, such as spraying, gravure coating, bar coating, knife coating, patting, screen printing, or dipping. At this time, the coated amount of the silicone rubber composition for textile coating is typically in a range of 25 to 150 g/m². Furthermore, after the silicone rubber composition is coated, the composition can be cured by heating at 150 to 200° C. for 1 to 2 minutes.

The silicone rubber coating layer of the present coated textile may be one layer or a multilayer with two or more layers. Furthermore, the present coated textile may further have any additional coating layers as necessary. Typically, such an additional coating layer is a layer for enhancing feeling to touch of the surface of the coated textile, further enhancing abrasion characteristics of the surface, and enhancing strength of the coated textile. Specific examples of such an additional coating layer include a coating layer formed from a plastic film, a textile, a nonwoven fabric, and another elastic coating agent.

### EXAMPLES

The silicone rubber composition for textile coating and the silicone rubber-coated textile of the present invention will be described in detail using examples. It should be understood that the present invention is not limited to the examples. In the physical properties of the silicone rubber were measured the following measurement methods in accordance with JIS.

### <Viscosity of Organopolysiloxane>

The viscosities at 25° C. (mPa·s) of the organopolysiloxanes were measured using a B type rotational viscometer in accordance with JIS K7117-1:1999 “Plastics-Resins in the liquid state or as emulsions or dispersions-Determination of apparent viscosity by the Brookfield Test method.”

### <Viscosity of Silicone Rubber Composition>

The viscosities at 25° C. (Pas) of the silicone rubber compositions for textile coating were measured using a rotational rheometer (a viscoelasticity measuring device AR 2000 manufactured by TA Instrument) in accordance with JIS K7117-2:1999 “Plastics-Polymers/resins in the liquid state or as emulsions or dispersions-Determination of viscosity using a rotational viscometer with defined shear rate.” The viscosities were measured by using a cone plate with a diameter of 20 mm, a cone angle of 2° and a shear rate of 10 (1/s).

### <Curability of Silicone Rubber Composition>

Curability of the silicone rubber composition was evaluated using a rheometer MDR 2000 (manufactured by Alpha Technologies, Ltd.). The curing temperature was 150° C. For the measurement, the time (minutes) taken to obtain 10% torque value was indicated by T10, and the time (minutes) taken to obtain 90% torque value was indicated by T90.

### <Characteristics of Silicone Rubber>

A silicone rubber sheet having a thickness of 2 mm was prepared by subjecting the silicone rubber composition to press vulcanization at a pressure of 20 MPa at 150° C. for 5 minutes. The hardness of the silicone rubber sheet was measured using a type A durometer stipulated in JIS K 6253-1997 “Hardness testing methods for rubber, vulcanized or thermoplastic,” or a spring durometer (Asker C hardness) stipulated in The Society of Rubber Industry, Japan Standard, SRIS 0101-1968 “Physical Testing Method for Expanded Rubber.” Furthermore, the tensile strength and the elongation at break of the silicone rubber were measured by methods stipulated in JIS K 6251:2004.

### <Heat-Aging>

The silicone rubber sheet produced above was subjected to dryer, as for Practical Examples 1 to 12 and Comparative Example 1 to 4, at 120° C. for 168 hours, and as for Practical Examples 13 to 22 and Comparative Examples 5 to 7, at 107° C. for 168 hours. Then, hardness, tear strength and elongation of the silicone rubber was measured.

### <Production of Silicone Rubber-Coated Textile>

A base fabric for curtain shield airbags formed from polyethylene terephthalate was coated on one surface with the silicone rubber composition using a Baker type applicator in a manner that the coated amount was 50 to 80 g/m². Then, the coated fabric was heated in an oven at 200° C. for 90 seconds to cure the silicone rubber composition. Similarly, the silicone rubber composition was also coated on the other face to produce a silicone rubber-coated textile.

### <Scrub Abrasion Resistance Test for Silicone Rubber-Coated Textile>

The silicone rubber-coated textile prepared above was subjected to “Scrub abrasion resistance test” by using a scrub resistance measuring apparatus (Twi-head Scrub Tester produced by J&E Engineering) in accordance with ISO 5981. The silicone rubber-coated textile was cut to 50 mm×100 mm. The load was adjusted to 1 kgf. After 600 cycles of the test, the surface of the silicone rubber-coated textile was observed. When delamination including pinhole was not observed, it was evaluated as “PASS.”

### Preparation Example 1

In a Ross mixer, 100 parts by mass of a dimethylpolysiloxane blocked with dimethylvinylsiloxy groups at both molecular chain terminals and having a viscosity of 54,000 mPa·s (a content of vinyl groups=approximately 0.09 mass %), 40 parts by mass of fumed silica having a BET specific surface area of 300 m²/g, 7 parts by mass of hexamethyldisilazane, and 2 parts by mass of water were charged and mixed at room temperature until the mixture became uniform. Thereafter, the mixture was subjected to heat treatment at 200° C. under reduced pressure for 2 hours to prepare a silica master batch with flowability.

### Practical Examples 1 to 22 and Comparative Examples 1 to 7

Silicone rubber compositions for textile coating were prepared by uniformly mixing at 25° C. the components described below at the constitutions shown in Tables 1 to 6. Silicone rubber sheets for measurement of physical properties were prepared by subjecting the silicone rubber compositions to transfer-press vulcanization at 150° C. for 5 minutes. Characteristics of the obtained silicone rubber composition for textile coating and the obtained silicone rubber are shown in Tables 1 to 6. Note that each [SiH/Vi] in Tables 1 to 6 indicates the number of moles of silicon atom-bonded hydrogen atoms of component (B) per 1 mole of the alkenyl groups in component (A).

The following organopolysiloxanes were used as component (A).
(a-1): a dimethylpolysiloxane blocked with dimethylvinylsiloxy groups at both molecular chain terminals and having a viscosity of 54,000 mPa·s (a content of vinyl groups=approximately 0.09 mass %)
(a-2): a dimethylpolysiloxane blocked with dimethylvinylsiloxy groups at both molecular chain terminals and having a viscosity of 370 mPa·s (a content of vinyl groups=approximately 0.48 mass %)

The following organopolysiloxanes were used as component (B).
(b-1): an organopolysiloxane represented by the following average formula:

(CH₃)₃SiO[(CH₃)₂SiO]_{5.1}[(CH₃)HSiO]_{2.9}Si(CH₃)₃
(a content of silicon atom-bonded hydrogen atoms=approximately 0.34 mass %)
(b-2): an organopolysiloxane represented by the average formula:

(CH₃)₃SiO[(CH₃)₂SiO]₃[(CH₃)HSiO],Si(CH₃)₃
(a content of silicon atom-bonded hydrogen atoms=approximately 0.77 mass %)
(b-3): an organopolysiloxane represented by the average formula:

(CH₃)₂HSiO[(CH₃)₂SiO]₁₄Si(CH₃)₂H
(a content of silicon atom-bonded hydrogen atoms=approximately 0.13 mass %)
(b-4): an organopolysiloxane represented by the following average formula:

(CH₃)₃SiO[(CH₃)₂SiO]_{5.7}[(CH₃)HSiO]_{3.6}Si(CH₃)₃
(a content of silicon atom-bonded hydrogen atoms=approximately 0.46 mass %)

The following hydrosilylation catalyst was used as component (C).
(c-1): 1,3-divinyltetramethyldisiloxane solution of 1,3-divinyltetramethyldisiloxane complex of platinum (a content of platinum metals=approximately 6,800 ppm)

The following component was used as component (D).
(d-1): silica master batch prepared in Preparation Example 1

The following adhesion promoters were used as component (E).
(e-1): a mixture of 50 parts by mass of zirconium tetraacetylacetonate and 50 parts by mass of a dimethylpolysiloxane blocked with dimethylvinylsiloxy groups at both molecular chain terminals and having a viscosity of 370 mPa·s (a content of vinyl groups=approximately 0.14 mass %)
(e-2): 3-glycidoxypropyltrimethoxysilane
(e-3): a copolymeric oligomer of dimethylsiloxane and methylvinylsiloxane blocked with silanol groups at both molecular chain terminals and having a viscosity of 20 mPa·s (a content of vinyl groups=approximately 10.9 mass %)

The following compounds were used as component (F).
(f-1): 3-(N-salicyloyl)amino-1,2,4-triazole (Mw=204; Mp=315-325° C.)
(f-2): 1-N, 12-N-bis(2-hydroxybenzoyl) dodecane dihydrazide (Mw=498; Mp=211-217° C.)
(f-3): N,N′-bis [3-(3,5-di-tert-butyl-4-hydroxyphenyl) propionyl]hydrazine (Mw=553; Mp=224-229° C.)
(f-4): 2,4,6-triamino-1,3,5-triazine (Mw=126; Mp=approximately 65° C.)
(f-5): N,N′-bis [3-(3,5-di-tert-butyl-4-hydroxyphenyl) propionyl]hexamethylene diamine (Mw=636; Mp=approximately 156° C.)

The following compounds were used as comparisons of component (F).
(f-6): 1,2,4-triazole (Mw=69; Mp=120-121° C.)
(f-7): 1,2,3-benzotriazole (Mw=119; Mp=99° C.)

The following components were used as component (G).
(g-1): a mixture of 2 parts by mass of 1-ethynylcyclohexan-1-ol and 98 parts by mass of a dimethylpolysiloxane blocked with dimethylvinylsiloxy groups at both molecular chain terminals and having a viscosity of 10,000 mPa·s (a content of vinyl groups=approximately 0.14 mass %)
(g-2): a mixture of 3 parts by mass of 1-ethynylcyclohexan-1-ol and 97 parts by mass of a dimethylpolysiloxane blocked with dimethylvinylsiloxy groups at both molecular chain terminals and having a viscosity of 370 mPa·s (a content of vinyl groups=approximately 0.48 mass %)

TABLE 1

| | | | Practical Examples | | | | | | |
|---|---|---|---|---|---|---|---|---|---|
| | | | 1 | 2 | 3 | 4 | 5 | 6 | 7 |
| Constitution | (A) | (a-1) | 36.4 | 36.4 | 36.4 | 36.4 | 36.4 | 36.4 | 36.0 |
| of Silicone | (B) | (b-1) | 4.22 | 4.22 | 4.22 | 4.22 | 4.22 | 4.22 | 4.48 |
| Rubber | | (b-2) | 0 | 0 | 0 | 0 | 0 | 0 | 0 |
| Composition | | (b-3) | 0 | 0 | 0 | 0 | 0 | 0 | 0 |
| (parts by mass) | (C) | (c-1) | 0.33 | 0.33 | 0.33 | 0.33 | 0.33 | 0.33 | 0.33 |
| | (D) | (d-1) | 154 | 154 | 154 | 154 | 154 | 154 | 154 |
| | (E) | (e-1) | 0.6 | 0.6 | 0.6 | 0.6 | 0.6 | 0.6 | 0.6 |
| | | (e-2) | 1.19 | 1.19 | 1.19 | 1.19 | 1.19 | 1.19 | 1.19 |
| | | (e-3) | 0.3 | 0.3 | 0.3 | 0.3 | 0.3 | 0.3 | 0.3 |
| | (F) | (f-1) | 0.05 | 0.3 | 0 | 0 | 0 | 0 | 0 |
| | | (f-2) | 0 | 0 | 0.2 | 0.3 | 0 | 0 | 0 |
| | | (f-3) | 0 | 0 | 0 | 0 | 0.4 | 1.0 | 0 |
| | | (f-4) | 0 | 0 | 0 | 0 | 0 | 0 | 0.04 |
| | | (f-5) | 0 | 0 | 0 | 0 | 0 | 0 | 0 |
| | | (f-6) | 0 | 0 | 0 | 0 | 0 | 0 | 0 |
| | | (f-7) | 0 | 0 | 0 | 0 | 0 | 0 | 0 |
| | (G) | (g-1) | 3.0 | 3.0 | 3.0 | 3.0 | 3.0 | 3.0 | 3.0 |
| SiH/Vi | | | 3.3 | 3.3 | 3.3 | 3.3 | 3.3 | 3.3 | 3.5 |
| Viscosity (Pa · s) | | | 134 | 138 | 136 | 137 | 136 | 140 | 136 |
| Curability | | T10 (sec) | 35 | 31 | 31 | 31 | 31 | 31 | 29 |
| | | T90 (sec) | 48 | 44 | 38 | 38 | 39 | 40 | 35 |
| Initial | Hardness | JIS A | 6 | 6 | 6 | 6 | 7 | 6 | 7 |
| | | Asker C | — | — | — | — | — | — | — |
| | Tensile Strength (MPa) | | 5.6 | 4.8 | 4.7 | 5.0 | 5.1 | 5.0 | 5.2 |
| | Elongation (%) | | 1529 | 1493 | 1502 | 1492 | 1492 | 1454 | 1492 |
| After | Hardness | JIS A | 12 | 11 | 16 | 15 | 14 | 14 | 13 |
| heat-aging | | Asker C | — | — | — | — | — | — | — |

| | | | | | | | |
|---|---|---|---|---|---|---|---|
| Tensile Strength (MPa) | 7.3 | 7.0 | 9.6 | 9.3 | 8.1 | 7.8 | 8.6 |
| Elongation (%) | 1285 | 1351 | 1191 | 1207 | 1205 | 1204 | 1307 |
| Relative retention | 84 | 90 | 82 | 81 | 81 | 83 | 88 |
| of Elongation (%) | | | | | | | |

TABLE 2

| | | | Practical Examples | | | Comparative Examples | | |
|---|---|---|---|---|---|---|---|---|
| | | | 8 | 9 | 10 | 1 | 2 | 3 |
| Constitution | (A) | (a-1) | 36.0 | 36.0 | 36.0 | 36.4 | 36.4 | 36.4 |
| of Silicone | (B) | (b-1) | 4.48 | 4.48 | 4.48 | 4.22 | 4.22 | 4.22 |
| Rubber | | (b-2) | 0 | 0 | 0 | 0 | 0 | 0 |
| Composition | | (b-3) | 0 | 0 | 0 | 0 | 0 | 0 |
| (parts by mass) | (C) | (c-1) | 0.33 | 0.33 | 0.33 | 0.33 | 0.33 | 0.33 |
| | (D) | (d-1) | 154 | 154 | 154 | 154 | 154 | 154 |
| | (E) | (e-1) | 0.6 | 0.6 | 0.6 | 0.6 | 0.6 | 0.6 |
| | | (e-2) | 1.19 | 1.19 | 1.19 | 1.19 | 1.19 | 1.19 |
| | | (e-3) | 0.3 | 0.3 | 0.3 | 0.3 | 0.3 | 0.3 |
| | (F) | (f-1) | 0 | 0 | 0 | 0 | 0 | 0 |
| | | (f-2) | 0 | 0 | 0 | 0 | 0 | 0 |
| | | (f-3) | 0 | 0 | 0 | 0 | 0 | 0 |
| | | (f-4) | 0.25 | 0 | 0 | 0 | 0 | 0 |
| | | (f-5) | 0 | 0.2 | 1.28 | 0 | 0 | 0 |
| | | (f-6) | 0 | 0 | 0 | 0 | 0.1 | 0 |
| | | (f-7) | 0 | 0 | 0 | 0 | 0 | 0.08 |
| | (G) | (g-1) | 3.0 | 3.0 | 3.0 | 3.0 | 3.0 | 3.0 |
| SiH/Vi | | | 3.5 | 3.5 | 3.5 | 3.3 | 3.3 | 3.3 |
| Viscosity (Pa · s) | | | 138 | 140 | 144 | 133 | 133 | 135 |
| Curability | | T10 (sec) | 28 | 32 | 30 | 31 | 37 | 59 |
| | | T90 (sec) | 36 | 40 | 36 | 39 | 83 | 115 |
| Initial | Hardness | JIS A | 6 | 5 | 8 | 7 | 4 | 5 |
| | | Asker C | — | — | — | — | 28 | — |
| | Tensile Strength (MPa) | | 4.8 | 4.0 | 5.1 | 5.3 | 4.8 | 4.7 |
| | Elongation (%) | | 1463 | 1593 | 1443 | 1482 | 1618 | 1543 |
| After | Hardness | JIS A | 12 | 13 | 14 | 19 | 12 | 14 |
| heat-aging | | Asker C | — | — | — | — | 38 | 41 |

| | | | | | | |
|---|---|---|---|---|---|---|
| Tensile Strength (MPa) | 8.3 | 7.9 | 8.8 | 11.1 | 7.7 | 9.1 |
| Elongation (%) | 1365 | 1304 | 1284 | 1098 | 1278 | 1238 |
| Relative retention | 93 | 82 | 89 | 74 | 79 | 80 |
| of Elongation (%) | | | | | | |

TABLE 3

| | | | | | Com- |
|---|---|---|---|---|---|
| | | | Practical | | parative |
| | | | Examples | | Example |
| | | | 11 | 12 | 4 |
| Constitution | (A) | (a-1) | 35.6 | 35.6 | 35.6 |
| of | (B) | (b-1) | 0 | 0 | 0 |
| Silicone | | (b-2) | 0.68 | 0.68 | 0.68 |
| Rubber | | (b-3) | 4.2 | 4.2 | 4.2 |
| Composition | (C) | (c-1) | 0.33 | 0.33 | 0.33 |
| (parts | (D) | (d-1) | 154 | 154 | 154 |
| by | (E) | (e-1) | 0.6 | 0.6 | 0.6 |
| mass) | | (e-2) | 1.19 | 1.19 | 1.19 |
| | | (e-3) | 0.3 | 0.3 | 0.3 |
| | (F) | (f-1) | 0.1 | 0. | 0 |
| | | (f-2) | 0 | 0.2 | 0 |
| | | (f-3) | 0 | 0 | 0 |
| | | (f-4) | 0 | 0 | 0 |
| | | (f-5) | 0 | 0 | 0 |
| | | (f-6) | 0 | 0 | 0 |
| | | (f-7) | 0 | 0 | 0 |
| | (G) | (g-1) | 3.0 | 3.0 | 3.0 |
| SiH/Vi | | | 2.4 | 2.4 | 2.4 |
| Viscosity (Pa · s) | | | 130 | 133 | 130 |
| Curability | | T10 (sec) | 30 | 31 | 31 |
| | | T90 (sec) | 50 | 54 | 65 |
| Initial | Hardness | JIS A | — | — | 7 |
| | | Asker C | 23 | 23 | — |
| | Tensile Strength (MPa) | | 2.7 | 2.5 | 4.4 |
| | Elongation (%) | | 1489 | 1517 | 1397 |
| After | Hardness | JIS A | — | — | 19 |
| heat- | | Asker C | 30 | 28 | — |

| | | | | |
|---|---|---|---|---|
| aging | Tensile Strength (MPa) | 4.2 | 3.8 | 10.4 |
| | Elongation (%) | 1413 | 1419 | 1106 |
| | Relative retention of | 95 | 94 | 79 |
| | Elongation (%) | | | |

TABLE 4

| | | | | | | | Comparative |
|---|---|---|---|---|---|---|---|
| | | | Practical Examples | | | | Example |
| | | | 13 | 14 | 15 | 16 | 5 |
| Constitution | (A) | (a-1) | 59.12 | 59.12 | 59.12 | 59.12 | 59.12 |
| of Silicone | | (a-2) | 1.51 | 1.51 | 1.51 | 1.51 | 1.51 |
| Rubber | (B) | (b-4) | 6.57 | 6.57 | 6.57 | 6.57 | 6.57 |
| Composition | (C) | (c-1) | 0.33 | 0.33 | 0.33 | 0.33 | 0.33 |
| (parts by mass) | (D) | (d-1) | 127.95 | 127.95 | 127.95 | 127.95 | 127.95 |
| | (E) | (e-1) | 0.6 | 0.6 | 0.6 | 0.6 | 0.6 |
| | | (e-2) | 1.19 | 1.19 | 1.19 | 1.19 | 1.19 |
| | | (e-3) | 0.3 | 0.3 | 0.3 | 0.3 | 0.3 |
| | (F) | (f-1) | 0.8 | 0 | 0 | 0 | 0 |
| | | (f-3) | 0 | 1.6 | 3.2 | 0 | 0 |
| | | (f-4) | 0 | 0 | 0 | 0.8 | 0 |
| | (G) | (g-2) | 2.44 | 2.44 | 2.44 | 2.44 | 2.44 |
| SiH/Vi | | | 4.8 | 4.8 | 4.8 | 4.8 | 4.8 |
| Viscosity (Pa · s) | | | 87 | 90 | 90 | 87 | 87 |
| Curability | | T10 (sec) | 27 | 28 | 28 | 28 | 31 |
| | | T90 (sec) | 30 | 31 | 32 | 31 | 35 |
| Initial | Hardness | JIS A | 10.8 | 10.9 | 11.6 | 10.7 | 10.4 |
| | | Asker C | 37 | 38 | 40 | 38 | 38 |
| | Tensile Strength (MPa) | | 6.7 | 6.6 | 6.4 | 6.9 | 6.5 |
| | Elongation (%) | | 1353 | 1336 | 1274 | 1344 | 1359 |
| After | Hardness | JIS A | 15.7 | 21.2 | 19.7 | 19.6 | 25.6 |
| heat-aging | | Asker C | 45 | 48 | 47 | 48 | 53 |

| | | | | | |
|---|---|---|---|---|---|
| Tensile Strength (MPa) | 7.0 | 6.8 | 6.8 | 8.4 | 8.5 |
| Elongation (%) | 1112 | 944 | 954 | 1060 | 830 |
| Relative retention | 82 | 71 | 75 | 79 | 61 |
| of Elongation (%) | | | | | |

| | | | | | |
|---|---|---|---|---|---|
| Scrub Resistance Test | PASS | PASS | PASS | PASS | PASS |

TABLE 5

| | | | | | | Comparative |
|---|---|---|---|---|---|---|
| | | | Practical Examples | | | Example |
| | | | 17 | 18 | 19 | 6 |
| Constitution | (A) | (a-1) | 59.12 | 59.12 | 59.12 | 60.99 |
| of Silicone | | (a-2) | 1.51 | 1.51 | 1.51 | 1.51 |
| Rubber | (B) | (b-4) | 4.7 | 4.7 | 4.7 | 4.7 |
| Composition | (C) | (c-1) | 0.33 | 0.33 | 0.33 | 0.33 |
| (parts by mass) | (D) | (d-1) | 127.95 | 127.95 | 127.95 | 127.95 |
| | (E) | (e-1) | 0.6 | 0.6 | 0.6 | 0.6 |
| | | (e-2) | 1.19 | 1.19 | 1.19 | 1.19 |
| | | (e-3) | 0.3 | 0.3 | 0.3 | 0.3 |
| | (F) | (f-1) | 0.8 | 0 | 0 | 0 |
| | | (f-3) | 0 | 1.6 | 0 | 0 |
| | | (f-4) | 0 | 0 | 0.8 | 0 |
| | (G) | (g-2) | 2.44 | 2.44 | 2.44 | 2.44 |
| SiH/Vi | | | 2.7 | 2.6 | 2.6 | 2.6 |
| Viscosity (Pa · s) | | | 91 | 93 | 95 | 90 |
| Curability | | T10 (sec) | 40 | 37 | 36 | 38 |
| | | T90 (sec) | 64 | 46 | 43 | 47 |
| Initial | Hardness | JIS A | 4.6 | 5.5 | 5.5 | 5.5 |
| | | Asker C | 27 | 29 | 29 | 29 |
| Tensile Strength (MPa) | | | 3.5 | 4.1 | 4.4 | 4.3 |
| Elongation (%) | | | 1493 | 1450 | 1481 | 1455 |
| After | Hardness | JIS A | 7.7 | 10.7 | 11 | 15.7 |
| heat-aging | | Asker C | 32 | 36 | 36 | 43 |

| | | | | |
|---|---|---|---|---|
| Tensile Strength (MPa) | 5.1 | 6.3 | 7.4 | 9.0 |
| Elongation (%) | 1383 | 1232 | 1293 | 1120 |
| Relative retention | 93 | 85 | 87 | 77 |
| of Elongation (%) | | | | |

TABLE 6

| | | | | | | Comparative |
|---|---|---|---|---|---|---|
| | | | Practical Examples | | | Example |
| | | | 20 | 21 | 22 | 7 |
| Constitution | (A) | (a-1) | 59.12 | 59.12 | 59.12 | 60.99 |
| of Silicone | | (a-2) | 1.51 | 1.51 | 1.51 | 1.51 |
| Rubber | (B) | (b-1) | 6.57 | 6.57 | 6.57 | 6.57 |
| Composition | (C) | (c-1) | 0.33 | 0.33 | 0.33 | 0.33 |
| (parts by mass) | (D) | (d-1) | 127.95 | 127.95 | 127.95 | 127.95 |
| | (E) | (e-1) | 0.6 | 0.6 | 0.6 | 0.6 |
| | | (e-2) | 1.19 | 1.19 | 1.19 | 1.19 |
| | | (e-3) | 0.3 | 0.3 | 0.3 | 0.3 |
| | (F) | (f-1) | 0.8 | 0 | 0 | 0 |
| | | (f-3) | 0 | 0.8 | 0 | 0 |
| | | (f-4) | 0 | 0 | 0.8 | 0 |
| | (G) | (g-2) | 2.44 | 2.44 | 2.44 | 2.44 |
| SiH/ Vi | | | 3.6 | 3.6 | 3.6 | 3.6 |
| Viscosity (Pa · s) | | | 88 | 88 | 87 | 87 |
| Curability | | T10 (sec) | 33 | 30 | 29 | 30 |
| | | T90 (sec) | 50 | 37 | 34 | 35 |
| Initial | Hardness | JIS A | 4.1 | 4.5 | 4.8 | 4.4 |
| | | Asker C | 27 | 28 | 28 | 27 |
| | Tensile Strength (MPa) | | 3.7 | 3.9 | 3.5 | 3.5 |
| | Elongation (%) | | 1639 | 1589 | 1570 | 1569 |
| After | Hardness | JIS A | 7.1 | 11.6 | 9.5 | 16.8 |
| heat-aging | | Asker C | 31 | 38 | 36 | 44 |

| | | | | |
|---|---|---|---|---|
| Tensile Strength (MPa) | 5.0 | 7.0 | 6.5 | 9.3 |
| Elongation (%) | 1451 | 1187 | 1324 | 1061 |
| Relative retention | 89 | 75 | 84 | 68 |
| of Elongation (%) | | | | |

### INDUSTRIAL APPLICABILITY

The silicone rubber composition for textile coating of the present invention forms silicone rubber which adheres firmly to a textile and has small change in elongation even when the silicone rubber is subjected to heat-aging. Therefore, the silicone rubber composition for textile coating is suitable as a coating agent for a textile used in, for example, airbags such as curtain shield airbags, driver airbags, passenger seat airbags, side airbags, knee airbags, and ITS head airbags; emergency escape seats for aircraft; and expandable rafts.

1. A silicone rubber composition for textile coating, comprising:
(A) 100 parts by mass of an organopolysiloxane having on average at least one alkenyl group per molecule and having a viscosity at 25° C. of from 100 to 1,000,000 mPa·s;
(B) an organopolysiloxane having at least two silicon atom-bonded hydrogen atoms per molecule, wherein a content of the silicon atom-bonded hydrogen atoms is 0.5 mass % or less, in an amount such that the silicon atom-bonded hydrogen atoms are 0.5 to 20 moles per one mole of alkenyl groups in component (A);
(C) a catalytic amount of a hydrosilylation catalyst;
(D) 0.1 to 50 parts by mass of a reinforcing silica fine powder;
(E) 0.05 to 5 parts by mass of an adhesion promoter; and
(F) 0.001 to 5 parts by mass of an amino group-containing triazine compound, or a compound having a phenol backbone and an amide bond, wherein each compound has a molecular weight of from 120 to 700.

2. The silicone rubber composition for textile coating according to claim 1, wherein component (E) is at least one selected from a group consisting of (E-1) an organotitanium compound and/or an organozirconium compound; (E-2) an epoxy group-containing alkoxysilane and/or an acryl group- or methacryl group-containing alkoxysilane; (E-3) a diorganosiloxane oligomer blocked with silanol groups at both molecular chain terminals; and a reaction product of components (E-2) and (E3).

3. The silicone rubber composition for textile coating according to claim 1, wherein component (F) has a melting point of 80° C. or more, and 300° C. or less, wherein the melting point is measured by means of a differential scanning calorimetry (DSC).

4. The silicone rubber composition for textile coating according to claim 1, wherein the amino group-containing triazine compound for component (F) is 2,4,6-triamino-1,3,5-triazine.

5. The silicone rubber composition for textile coating according to claim 1, wherein the compound having a phenol backbone and an amide bond for component (F) is a triazole compound, a diamine compound or a hydrazine compound.

6. The silicone rubber composition for textile coating according to claim 1, further comprising:
(G) a hydrosilylation retardant, in an amount of from 0.001 to 5 parts by mass per 100 parts by mass of component (A).

7. A silicone rubber-coated textile cured product formed by coating a textile with the silicone rubber composition for textile coating according to claim 1, and then curing the composition.

8. The silicone rubber-coated textile according to claim 7, wherein the textile is a base fabric for an airbag.
